(19) United States
(12) Patent Application Publication
(10) Pub. No.: US 2024/0022279 A1
(43) Pub. Date: Jan. 18, 2024

(54) ON-CHIP ACTIVE RESONATOR BASED SPECTRUM SENSING

(71) Applicant: Northeastern University, Boston, MA (US)

(72) Inventor: Aatmesh Shrivastava, Boston, MA (US)

(21) Appl. No.: 18/221,081

(22) Filed: Jul. 12, 2023

Related U.S. Application Data
(60) Provisional application No. 63/388,364, filed on Jul. 12, 2022.

(51) Int. Cl. H04B 1/40; H04W 16/14; H04W 16/10; H04B 17/382

(52) U.S. Cl. CPC H04B 1/40; H04W 16/14; H04W 16/10; H04B 17/382

(57) ABSTRACT

A cognitive radio (CR) based transceiver system including a receiver configured to sense a predetermined frequency band for a CR signal, wherein the CR signal includes phase noise, a transmitter configured to select a channel for CR signal transmission based on the predetermined frequency band, and generate a carrier frequency for the selected channel, and a trained machine learning model configured to correct the phase noise included in the CR signal.

### CROSS-REFERENCE TO RELATED APPLICATIONS

This application claims the benefit of priority to U.S. Provisional Application No. 63/388,364, filed Jul. 12, 2022.

### FIELD OF THE DISCLOSED SUBJECT MATTER

The disclosed subject matter relates to a cognitive radio (CR) receiver for precision navigation and timing (“PNT”) applications and a CR transmitter for PNT applications. Particularly, the present disclosed subject matter is directed to a CR transceiver system of a chip.

### BACKGROUND OF THE DISCLOSED SUBJECT MATTER

PNT needs for both military and civilian applications are primarily enabled by GPS. While GPS can provide navigational accuracy down to a few meters, its accuracy degrades in a multipath environment, and various DoD applications involving drones and mobile platforms require navigational accuracy down to centimeters. Further, GPS signal is weak at the receiver and its carrier frequency is known, making it prone to jamming and spoofing attacks, which can disrupt the GPS based industry and pose a risk to our critical infrastructure. Critical civilian and military applications require precise navigational capabilities in a GPS-denied environment.

There thus remains a need for an efficient and economic method and system for a CR transceiver system on a chip.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a cognitive radio (CR) based transceiver system, which may be on a chip, the system including a receiver comprising a plurality of active resonators, wherein the receiver is configured to sense a predetermined frequency band for a CR signal, wherein the CR signal includes phase noise, a transmitter configured to select a channel for CR signal transmission based on the predetermined frequency band, and generate a carrier frequency for the selected channel and a trained machine learning model configured to correct the phase noise included in the CR signal.

The disclosed subject matter also includes a cognitive radio (CR) receiver, the receiver including a low noise amplifier (LNA) electrically coupled in parallel with both an automatic gain control (AGC) and a received signal strength indicator (RSSI) circuit, wherein the RSSI circuit comprises a plurality of limiting amplifiers, a plurality of active resonators electrically coupled in series to an output of the LNA, a plurality of rectifiers electrically coupled in series to the plurality of active resonators, summation circuitry, electrically coupled in series to the plurality of rectifiers, and a trained machine learning model electrically coupled in series to the summation circuitry, wherein the receiver is configured to sense a predetermined frequency band for a CR signal, wherein the summation circuitry is configured to sum outputs of the plurality of rectifiers and to provide the summed outputs to the trained machine learning model, and wherein the trained machine learning model is configured to correct phase noise included in a CR signal.

The disclosed subject matter also includes a cognitive radio (CR) transmitter, the transmitter including an oscillator, a modulator, a power amplifier (PA) and an antenna, wherein the oscillator, the modulator, the PA, and the antenna are electrically coupled in series, and wherein the transmitter is configured to: select a channel for CR signal transmission based on a predetermined frequency band and generate a carrier frequency for the selected channel.

The discloses subject matter also includes an active resonator, the resonator including a transconductance stage followed by a common-source stage used in a negative feedback, wherein the transconductance stage corresponds to a transconductance value, the transconductance stage and the common-source stage correspond to an output resistance value, and the active resonator is associated with a quality factor, a plurality of output capacitors electronically coupled to the transconductance stage and the common-source stage and a detuning resistor electronically coupled to the transconductance stage and the common-source stage, wherein the detuning resistor is configured to control the quality factor, wherein the active resonator is configured to have a programmable resonant frequency.

The foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a schematic circuit diagram of a CR receiver architecture using active resonators, rectifiers and a machine-learning based timing recovery circuit in accordance with the disclosed subject matter.

FIG. 2 is a schematic circuit diagram of an on-chip active resonator in accordance with the disclosed subject matter.

FIG. 3 is a depiction of a frequency response of the resonator in FIG. 1A in accordance with the disclosed subject matter.

FIG. 4 is a depiction of a frequency response programming using a transconductance value in accordance with the disclosed subject matter.

FIG. 5 is a depiction of a frequency response reduction in accordance with the disclosed subject matter.

FIG. 6 is a depiction of a step response settling time of the output of the resonator in accordance with the disclosed subject matter.

FIG. 7 is a plot of the resonator's transient output noise in accordance with the disclosed subject matter.

FIG. 8 is a schematic circuit diagram with two active resonators in accordance with the disclosed subject matter.

FIG. 9 is a narrow band sensing using differential-Q active resonators to remove adjacent blockers in accordance with the disclosed subject matter.

FIG. 10 is a plot of frequency response for different active resonators across frequencies in accordance with the disclosed subject matter.

FIG. 11 is a schematic circuit diagram of a RSSI circuit in accordance with the disclosed subject matter.

FIG. 12 is a simulation of the frequency response of the RSSI circuit with different Vo in accordance with the disclosed subject matter.

FIG. 13 is a schematic diagram of a CR transmitter using the active resonator in accordance with the disclosed subject matter.

FIG. 14 depicts a plot of the transient simulation of a 12 GHz oscillator designed using a 12 GHz resonator in accordance with the disclosed subject matter.

FIG. 15 depicts the simulation results of the circuit in FIG. 10 in accordance with the disclosed subject matter.

FIG. 16 depicts symbol overlays of the received symbol and the resultant symbol in accordance with the disclosed subject matter.

FIG. 17 is a schematic diagram of a Machine-Learning (ML) based phase noise correction technique for two-way time transfer in accordance with the disclosed subject matter.

FIG. 18 depicts a computing node in accordance with the disclosed subject matter.

### DETAILED DESCRIPTION

Reference will now be made in detail to exemplary embodiments of the disclosed subject matter, an example of which is illustrated in the accompanying drawings. The method and corresponding steps of the disclosed subject matter will be described in conjunction with the detailed description of the system.

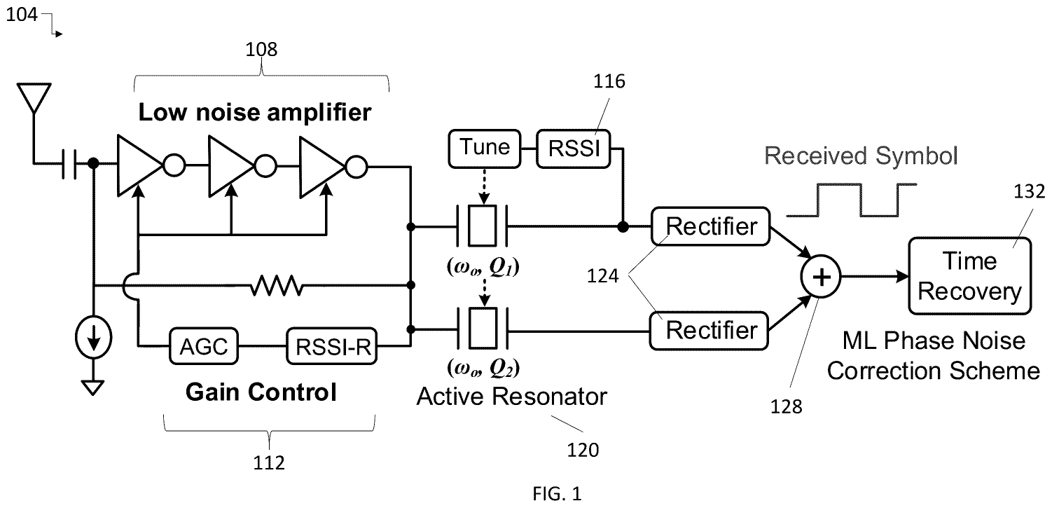

The methods and systems presented herein may be used for a CR transmitter and CR receiver configured to PNT applications. The disclosed subject matter is particularly suited for a CR based transceiver system on a chip. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

As shown in FIG. 1, a cognitive radio (CR) based transceiver system 100 includes a receiver 104. Receiver 104 is configured to sense a predetermined frequency band for a CR signal, wherein the CR signal includes phase noise. A cognitive radio (CR) receiver 104 for precision navigation and timing (PNT) applications includes a low noise amplifier (LNA) 108 electrically coupled in parallel with both an automatic gain control (AGC) 112 and a received signal strength indicator (RSSI) circuit 116, wherein the RSSI circuit 116 comprises a plurality of limiting amplifiers. In various embodiments, the RSSI circuit 116 is configured to determine the power level of the CR signal. In various embodiments, the RSSI circuit 116 is configured to control a gain of the LNA 108, wherein the RSSI circuit 116 is further configured to prevent the saturation of the output in a received path for the AGC 112. In various embodiments, the RSSI circuit 116 is configured to continuously detect instability in the CR signal.

Receiver 104 includes a plurality of active resonators electrically coupled in series to an output of the LNA 108. In various embodiments, each active resonator 120 of the plurality of active resonators 120 includes a programmable resonant frequency, and wherein each active resonator 20 of the plurality of active resonators 120 is associated with a quality factor. Receiver 104 includes a plurality of rectifiers 124 electrically coupled in series to the plurality of active resonators 120. Receiver 104 includes summation circuitry 128, electrically coupled in series to the plurality of rectifiers 124.

Receiver 104 includes a trained machine learning model 132 electrically coupled in series to the summation circuitry, 128 wherein the receiver 104 is configured to sense a predetermined frequency band for a CR signal, wherein the summation circuitry 128 is configured to sum outputs of the plurality of rectifiers 124 and to provide the summed outputs to the trained machine learning model 12. In various embodiments, the trained machine learning model 132 is configured to correct phase noise included in a CR signal.

Receiver 104 may include a low noise amplifier (LNA) 108 electrically coupled in parallel with both an automatic gain control (AGC) 112 and a received signal strength indicator (RSSI) 116 circuit, wherein the RSSI 116 circuit comprises a plurality of limiting amplifiers. A wide-band low-noise amplifier (LNA) 108 circuit may be used to amplify the RF signal. A parallel AGC 112 using receiver RSSI (RSS-R) is used to prevent the receiver from saturating. The LNA 108 output is fed to active resonators operating differentially as discussed herein. In various embodiments, the receiver further comprises a plurality of rectifiers electrically coupled in series to the plurality of active resonators. The output of the both resonators are fed to rectifiers to demodulate the signal. The rectifier outputs are then summed together to remove out of band and adjacent channel interferers. Finally, the received signal will still suffer from fading and multi-path effects which may be recovered using machine-learning based phase noise correction scheme.

In various embodiments, the RSSI 116 circuit is configured to determine the power level of the CR signal. In various embodiments, the RSSI 116 circuit is configured to control a gain of the LNA 108, wherein the RSSI 116 circuit is further configured to prevent the saturation of the output in a received path for the AGC 112. In various embodiments, the RSSI 116 circuit is configured to continuously detect instability in the CR signal.

Conventional resistive feedback based LNA 108, which can provide high gain with low noise may be used in this project. Some of these techniques involving additional noise cancelling method and multi-stage design with input capacitance cancellation technique can be leveraged in the proposed CR architecture. The resistive feedback base LNA architecture with an RSSI-R based AGC scheme may be utilized.

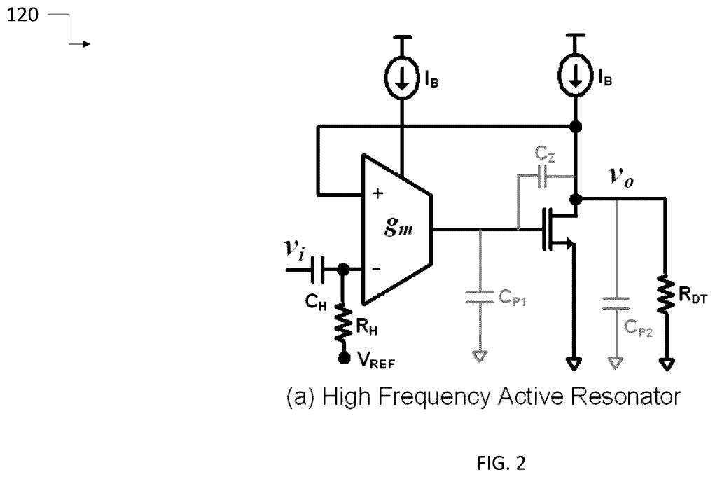

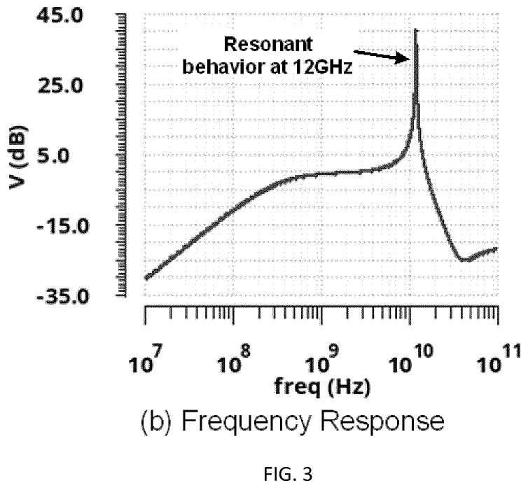

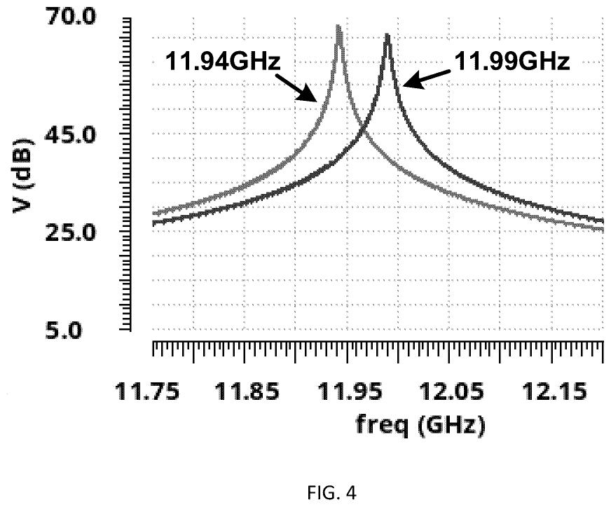

In various embodiments, receiver 104 includes a plurality of active resonators 120 electrically coupled in series to an output of the LNA. A schematic circuit diagram of an active resonator 120 is shown in FIG. 2. In various embodiments, each active resonator 120 of the plurality of active resonators includes a programmable resonant frequency, and wherein each active resonator 120 of the plurality of active resonators is associated with a quality factor. Active resonator 120 includes a gₘ stage followed by a common-source stage used in a negative feedback. If both stages have a similar transconductance value (gₘ) and output capacitors (Cₚ₁=Cₚ₂=Cz) then the active resonator 120 will show resonance (at ω₀=gm/sp) due to underdamped 2^{nd} order feedback system. The quality factor (Q) of the resonator is given by ˜2gₘr₀ where r₀ is the output resistance of each stage. A high Q value up to a few thousand can be realized using this structure by selecting gₘ and r₀. The frequency response of the resonator at 12 GHz is shown in FIG. 3. The resonator circuit will amplify a RF signal at 12 GHz, which can be detected by an energy detector circuit. The programming of the resonator is achieved by changing the gₘ by changing the bias current I_{B}. The change in resonance frequency of the resonator from 11.94 GHz to 11.99 GHz when the value of I_{B} changes from 300 mA to 302 mA as shown in FIG. 4. A consequence of the realized high Q of the active resonator 120 is the low phase margin, bordering instability for the 2^{nd} order system. The value of Q and stability can be controlled using a detuning resistor (RDT) as shown in FIG. 2. By reducing the value of RDT, the system can be prevented from being oscillatory. In various embodiments, any active resonator 120 described herein may form a portion of a filter. In various embodiments, any active resonator 120 described herein may be formed, at least in part by a filter having poles corresponding to one or more resonant frequencies. In various embodiments, any resonator 120 described herein may be modelled or partially modeled as a filter having poles, the poles being closely located, each pole corresponding to a resonant frequency of the active resonator.

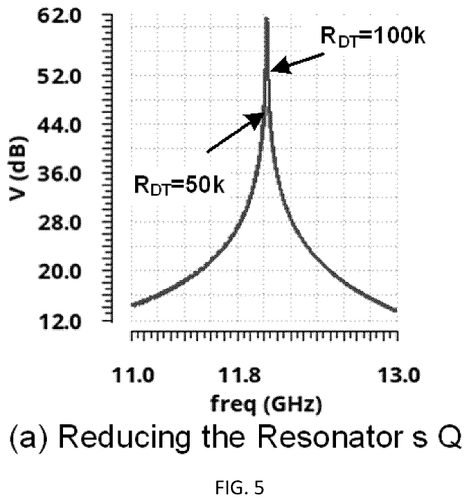

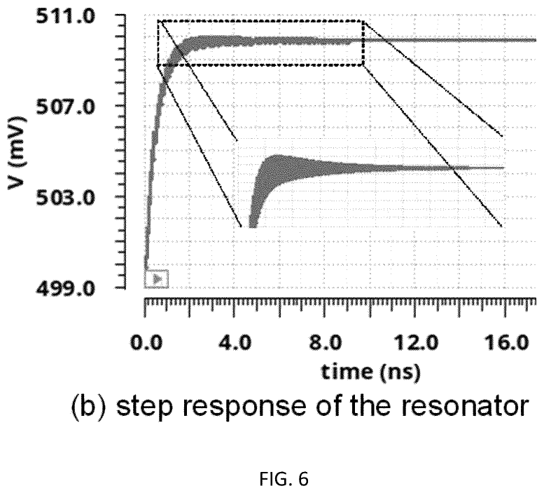

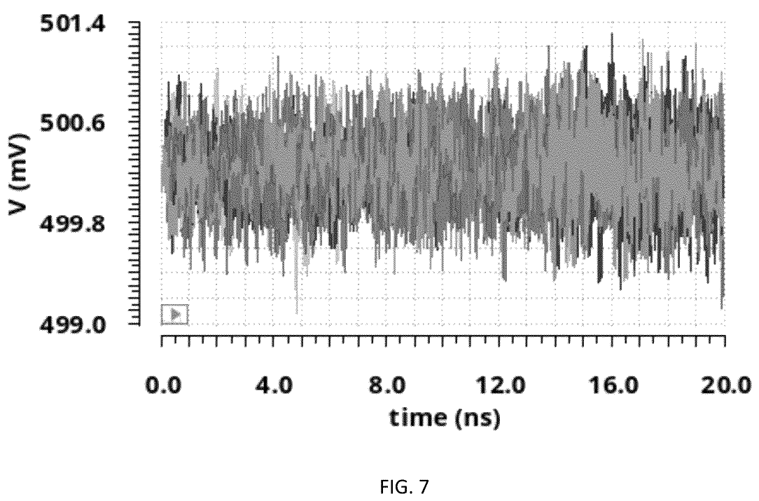

FIG. 5 depicts the peaking gain of the system reduced from 62-dB to 45 dB by hanging the value of RDT from 100 kΩ to 50 kΩ The resonator may be made stable, but its settling time due to any perturbation (step response) at high Q value can be of concern. However, this concern is reduced at high frequency. A high-Q system can take several cycles to settle, but at high frequency that can still be a relatively small time. FIG. 6 depicts the settling time of the output of the resonator when a 10 mV step (a relatively large perturbation on-chip) is applied at the reference voltage V_{REF}. A resonator designed for 12 GHz settles in 10 ns. The noise performance of the active resonator by simulating 10 different noise seeds in SPICE was also simulated and depicted in FIG. 7. The peak-peak noise at the output of the resonator is 1.5 mV which roughly translates to an input referred noise of 15 μV. If the LNA 108 gain is set at 20 dB, the power detector with the proposed resonator can detect signal power above −90 dBm.

In various embodiments, the programmable resonant frequencies of the plurality of active resonators 120 are the same. In various embodiments, the quality factor associated with each active resonator 120 of the plurality of active resonators is different to the quality factors associated with each of the other active resonators 120 of the plurality of resonators. The use of active resonator 120 shows an ability to sense available RF bands for cognitive communication. However, the Q of the proposed on-chip resonator is still not very high. It can sense RF-media over a wide-band. In cognitive communication application however, such broad RF bands may be completely empty as studies show. However, a strong out of band adjacent blocker can make a wide spectrum unavailable. This has been a design concern in conventional RF receivers. Several blocker tolerant architectures have been proposed in the literature, including mixer first architecture. However, these blockers can only operate at known frequencies, whereas in cognitive communication blockers should operate across a wide frequency.

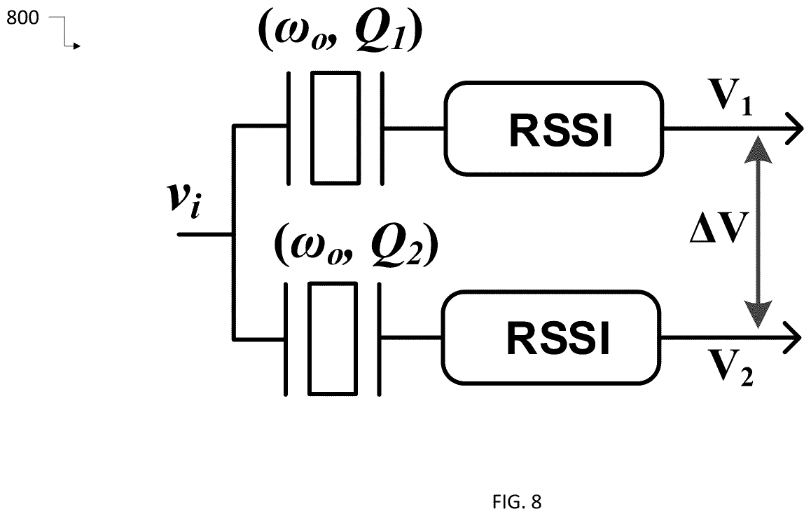

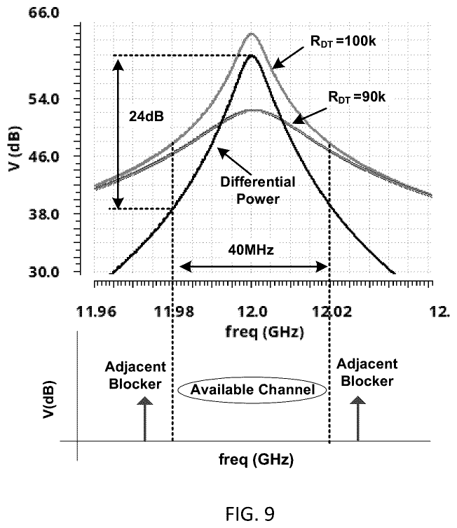

Referring now to FIG. 8, a schematic circuit 800 with two active resonators in accordance with the disclosed subject matter. A narrow-band power sensing to enable a narrow-band communication channel selection is more desirable. This can be accomplished in our proposed sensing technique using two active resonators with same resonance frequency (wo) but different quality factors (Q₁ and Q₂). In case there is an RF power at wo, each active resonator will provide different gain to the incoming signal owing to their different Q-factor. Consequently, a differential voltage ΔV) will be developed at the output of the RSSI circuit as shown in FIG. 8. However, absence of RF power at ω₀ will result in a delta V˜=0, indicating the availability of that channel for cognitive communication. Note that this proposed differential technique will also help in reducing the noise level making the design more sensitive. FIG. 6 shows the circuit simulation of the proposed concept. Two resonators with resonance frequency of 12 GHz are simulated. One resonator has a higher Q with RDT=100 kΩ (in red), while the other resonator has a lower Q with RDT=90 kΩ (in blue). The power differential at the output of two resonator is also plotted (in black). FIG. 9 shows that the differential power attenuates rapidly. At ±20 MHz offset, the adjacent blocker's power is 24 dB below the resonance frequency power level. Even a narrower channel with higher attenuation for adjacent blocker is possible through the higher Q realization for the resonators. FIG. 9 depicts the realization of a 40 MHz channel at 12 GHz. For contrast, IEEE 802.11ac allows for 160 MHz channel at 5 GHz.

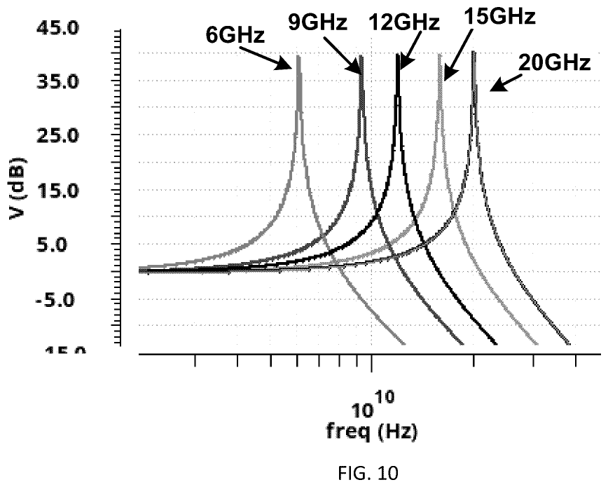

A narrow channel sensing can be achieved at 12 GHz. To sense the availability of communication channels across a wide band, the value of gₘ can be swept by changing I_{B} to cover a wide range of frequency around 12 GHz (such as the range in FIG. 4). In various embodiments, there is an active resonator 120 for each GHz band from 1-20 GHz band, each pair tuned for a GHz band. Each resonator pair will sense the RF media in parallel. FIG. 10 shows the simulation result of 5 different resonators designed for 6, 9, 12, 15, and 20 GHz frequencies. Further, each GHz band may be swept in a 40 MHz step. Power in each channel can be sensed within 40 ns using the RSSI circuit and the entire 1-20 GHz band can be sensed for available channels in less than 1 μs.

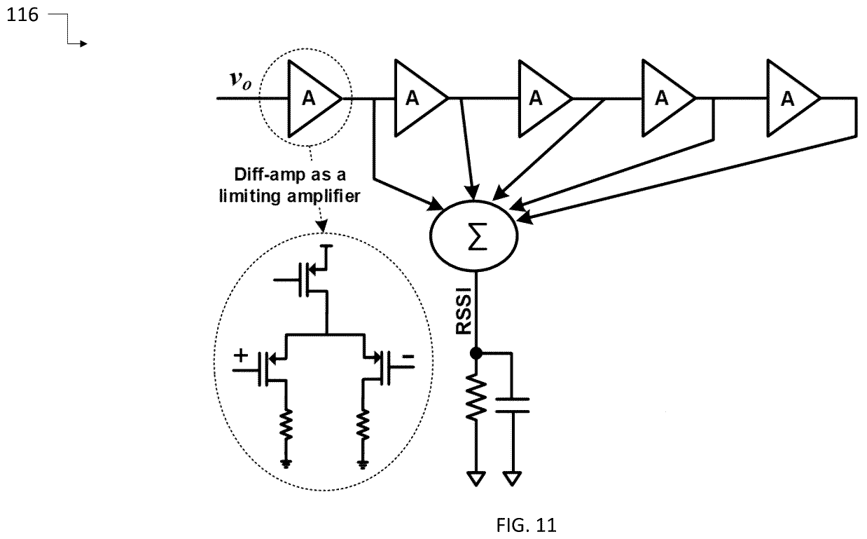

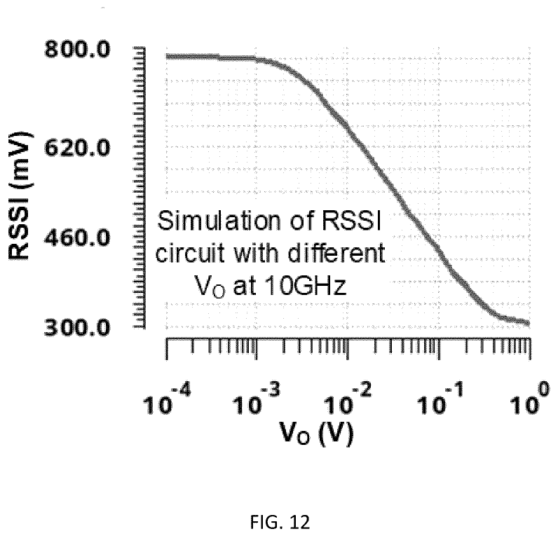

FIG. 11 is a schematic circuit diagram of a RSSI circuit 116 in accordance with the disclosed subject matter. RSSI 116 may be used to control gain by obtaining the power level of the incoming signal. FIG. 11 shows a design of an RSSI 116 circuit that implement five diff-amp based limiting amplifiers. FIG. 12 shows the simulation result of our preliminary RSSI circuit 116, revealing a linear behavior with respect to the input voltage Vo, which is the output of a 10 GHz active resonator with input varying from 0.1 mV to 1 V. In this project, RSSI circuit will be used to perform three main functions. First, in the spectrum sensing mode of the CR-system, RSSI will provide power level of the received RF signal. For the receiver circuit, RSSI will be used to control the gain of LNA to prevent the saturation of the output in the received path for an automatic gain control (AGC). Thirdly, RSSI will also be used to continuously detect the instability which can manifest due to variations. The oscillations can be detected by the RSSI when its output gives a low value while RF channel is disabled. The RSSI output in this case will be used to reduce the RDT of the resonator to prevent oscillation.

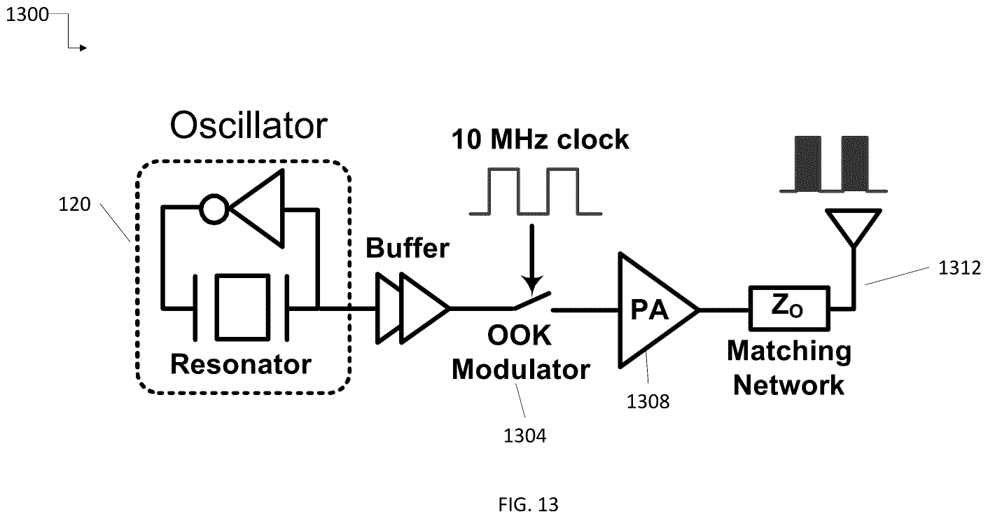

Referring now to FIG. 13 is a schematic diagram of a CR transmitter 1300 using the active resonator 120 in accordance with the disclosed subject matter. Transmitter 1300 may be configured to select a channel for CR signal transmission based on the predetermined frequency band and generate a carrier frequency for the selected channel. Transmitter 1300 may include an oscillator, which may include resonator 120. In various embodiments, transmitter 1300 may include a modulator 1304. Transmitter 1300 may include a power amplifier (PA) 1308. In various embodiments, transmitter 1300 may include an antenna 1312. In various embodiments, the oscillator 120, modulator 1304, PA 1308 and antenna 1312 may be electrically coupled in series.

In various embodiments, cognitive radio (CR) transmitter 1300 for precision navigation and timing (PNT) applications includes an oscillator, wherein the oscillator comprises at least one active resonator 120 electrically coupled in parallel with a high-bandwidth inverting amplifier. The transmitter 1300 includes a modulator 1304, a power amplifier (PA) 1308 and an antenna 1312. In various embodiments, the oscillator, modulator 1304, PA 1308 and antenna 1312 are electrically coupled in series, wherein the transmitter 1300 is configured to select a channel for CR signal transmission based on a predetermined frequency band and generate a carrier frequency for the selected channel.

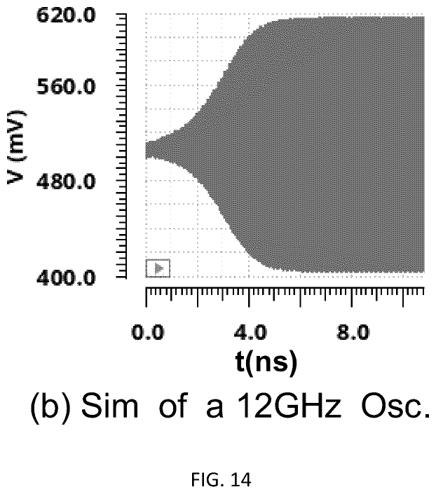

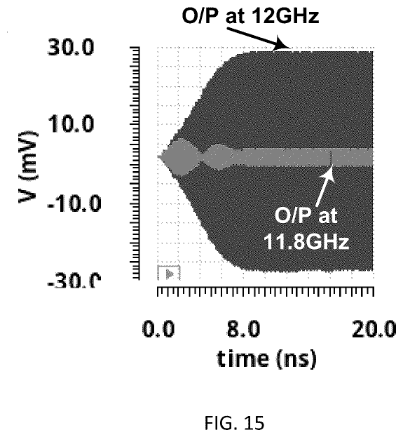

Once the channels are known, they can be utilized for communication, which requires the generation of carrier frequency for the selected channel. In various embodiments, active resonator 120 generates the carrier frequency. In various embodiments, the oscillator may include at least one active resonator 120 electrically coupled in parallel with a high-bandwidth inverting amplifier. In this case, the resonator is connected across a high-bandwidth inverting amplifier as shown in FIG. 13. This forms an oscillator whose resonance frequency will be determined by the resonator 120. FIG. 14 shows the transient simulation result of a 12 GHz oscillator designed using a 12 GHz resonator. The oscillator settles in less than 10 ns. The phase noise of the 12 GHz oscillator which was −60 dBc/Hz at 1 MHz offset to provide enough performance for the OOK transmitter 1300 and energy-detection based receiver 104 is also simulated, the results shown in FIG. 15. In various embodiments, a high-precision 10 MHz local dock (timer) will be used for OOK modulation.

In various embodiments, system 100 includes a trained machine learning model 132 configured to correct the phase noise included in the CR signal. In various embodiments, the receiver 104 further comprises summation circuitry, electrically coupled in series to the plurality of rectifiers, and configured to sum outputs of the plurality of rectifiers, and to provide the summed outputs to the trained machine learning model. In various embodiments, the trained machine learning model is trained with a plurality of samples of an envelope of a received RF signal. In various embodiment, the trained machine learning model comprises a timing error function that includes each of the plurality of samples of the envelope of the received RF signal multiplied by a weight associated with that sample.

In the proposed OOK communication, symbol distortion will occur due to fading caused by in-channel multi-path propagation or shadowing effects. The arrival of RF signal through multiple paths at different amplitude and at different time will result into phase offsets in the symbol causing a timing inaccuracy for two-way accurate time-transfer. Fading is one of the dominant sources of error for PNT application. A conventional approach to eliminate fading includes time domain based least square method and frequency domain based inverse correlation method but this can take a long time to predict the error. In various embodiments, ML based phase noise correction scheme 132 for the received symbol may be configured to produce a fast error resolution scheme.

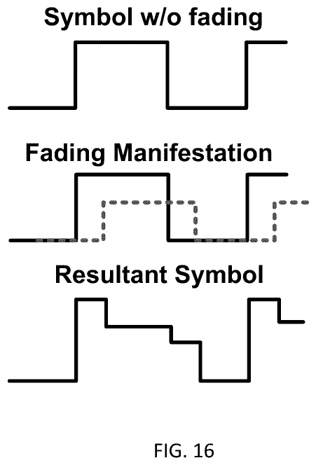

FIG. 16 shows how fading manifests in the received symbol where one symbol overlays over the other producing a resultant symbol. The envelope of the resultant symbol contains the features that are causing fading. In our proposed OOK receiver architecture, the received symbol is the envelope of the RF signal and it contains the features that are causing fading. The timing error due to fading will correlate with these features. In various embodiments, one or more components of the system may sample the 10 MHz demodulated symbol (timer frequency) using al GS/s ADC to store the sampled values of one symbol in the memory to mapping its feature space. In various embodiments, the timing error ΔT, may be a function of the envelope and can follow a linearized error model given by ΔT=Σᵢ₌ᵢ¹⁰⁰VᵢWᵢ where Vᵢ is the time-sample of the envelop and Wᵢ is the weight, Using the known ΔT and the known V, values, the model can be trained to generate optimal values of Wi for minimum timing error.

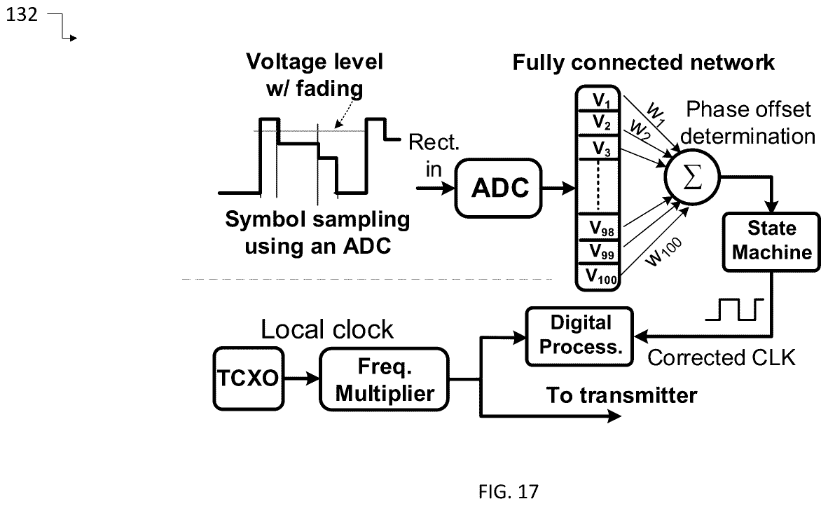

FIG. 17 is a schematic diagram of a Machine-Learning (ML) based phase noise correction technique for two-way time transfer in accordance with the disclosed subject matter. The trained model 132 can then be used to generate the corrected phase. A state machine will apply this phase offset in the received signal to correct the dock, removing the effect of fading. Once the phase error is removed, the recovered symbol can be used to determine the error between the two clocks. The clock error can be corrected by changing the control voltage of TCXO. The time recovery scheme will take less than 10 cycles and can be done within 1 μs. In various embodiments, with a 1GS/s ADC sampling and a single layer ML based correction scheme, a higher ADC sampling at SGS/s or multi-layer convolution-based ML can also be considered for even higher accuracy. In various embodiments, the herein disclosed system may achieve less than 10 ps of timing error. The tradeoffs between accuracy and fast resolution of error may also be considered. To train the proposed ML model 132, training data in a variety of application scenarios that cause fading effects may be collected. Software defined radio (SDR) transmitter 1300 and receiver 104 may be used in different application space such as crowded urban areas, high traffic volume areas (near interstates), among other scenarios to obtain the training data.

In various embodiments, training data may be collected from any location and stored in a datastore. In various embodiments, data are provided from sensors, and/or the datastore to a machine learning system. In various embodiments, data may be provided to the learning system in real time. In various embodiments, by receiving data live from the user, learning system provides high level analysis that provides adjustment and adaptation of a environment, through changes in the various parameters according to the recorded data.

In some embodiments, a feature vector is provided to the learning system. Based on the input features, the learning system generates one or more outputs. In some embodiments, the output of the learning system is a feature vector.

In some embodiments, the learning system comprises a SVM. In other embodiments, the learning system comprises an artificial neural network. In some embodiments, the learning system is pre-trained using training data. In some embodiments training data is retrospective data. In some embodiments, the retrospective data is stored in a data store. In some embodiments, the learning system may be additionally trained through manual curation of previously generated outputs.

In some embodiments, the learning system is a trained classifier. In some embodiments, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

Precision Timer, Time-Transfer and Synchronization: in various embodiments, both nodes, in a two-way time transfer scheme, will maintain a precision clock whose relative timing error with respect to each other is very low (in ppb) using TCXO or chip-scale atomic dock (C SAC). For time transfer, each node can send a symbol at the end of every second. Each node can wake up at 2 μs before the n-th second and identify available communication channel (within 11.6) and tune the transmitter and receiver circuit. At the end of a second, each node can send their timing symbol using a given CR channel. The delay of arrival of the symbol and the drift between two clocks can be used to calculate the pseudo-range using TDoA technique for PNT applications.

Chip Design and Power Consumption: The complete CR system along with the ML based phase noise correction scheme will be integrated on a chip. The CR system can sense the channel in 1 μs and be ready for communication in the next μs, while conventional radio takes 10 s of ms to startup. It is easier to duty-cycle the proposed CR system. A target of 20 mW power consumption for the CR system when active with active time being low (<5 μs) for time transfer. Assuming time transfer every second, average power consumption can be as low as 100 nW. The proposed work will have a major impact on the Swap-C of existing CR systems which are heavy back-pack system.

Although this disclosure includes a detailed description of a chip, implementation of the teachings recited herein are not limited to any one computing environment. Rather, embodiments of the present disclosure are capable of being implemented in conjunction with any other type of computing environment or cloud computing environment now known or later developed.

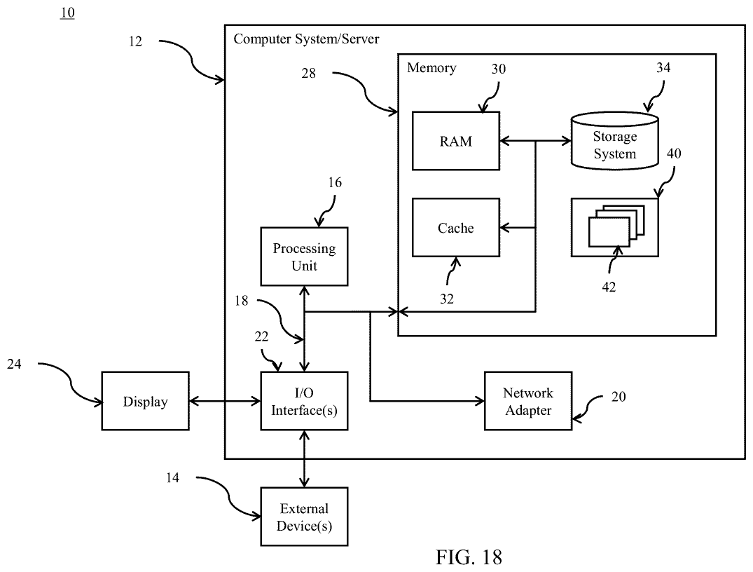

Referring now to FIG. 18, a schematic of an example of a computing node is shown. computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 18, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16. Computing node 10 may include or be wholly formed by any component described herein, such as the receiver 104, transmitter 1300, and any component thereof, including any circuitry described. In various embodiments, computing node 10 may include LNA 108, gain control 112, one or more active resonator 120, one or more rectifiers 124, one or more RSSI circuits 116, one or more ML models 132 among others. Further, in various embodiments, computing node 10 may include modulator 1304, power amplifier 1308 and antenna 1312.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Computer system/server 12 may also communicate with an antenna as described herein, such as receiver 104, transmitter 1300, and specifically antenna 1312, in embodiments. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A cognitive radio (CR) based transceiver system, comprising:
a receiver comprising a plurality of active resonators, wherein the receiver is configured to sense a predetermined frequency band for a CR signal, and the CR signal includes phase noise;
a transmitter configured (i) to select a channel for CR signal transmission based on the predetermined frequency band, and (ii) to generate a carrier frequency for the selected channel; and
a trained machine learning model configured to correct the phase noise included in the CR signal.

2. The system of claim 1, wherein the receiver comprises a low noise amplifier (LNA) electrically coupled in parallel with both an automatic gain control (AGC) and a received signal strength indicator (RSSI) circuit, and the RSSI circuit comprises a plurality of limiting amplifiers.

3. The system of claim 2, wherein the RSSI circuit is configured to determine the power level of the CR signal; and the RSSI circuit is configured to continuously detect instability in the CR signal.

4. The system of claim 2, wherein the RSSI circuit is configured to control a gain of the LNA, and the RSSI circuit is further configured to prevent saturation of the output in a received path for the AGC.

5. (canceled)

6. (canceled)

7. The system of claim 1, wherein the plurality of active resonators is electrically coupled in series to an output of the LNA, and each active resonator of the plurality of active resonators comprises a programmable resonant frequency, and each active resonator of the plurality of active resonators is associated with a quality factor.

8. The system of claim 7, wherein each active resonator of the plurality of active resonators comprises a transconductance stage followed by a common-source stage used in a negative feedback, and each active resonator of the plurality of active resonators comprises a detuning resistor configured to control the quality factor.

9. The system of claim 7, wherein the programmable resonant frequencies of each of the plurality of active resonators is the same, and the quality factor associated with each active resonator is unique.

10. The system of claim 1, wherein the receiver further comprises:
a plurality of rectifiers electrically coupled in series to the plurality of active resonators; and
summation circuitry, electrically coupled in series to the plurality of rectifiers, and configured to:
sum outputs of the plurality of rectifiers, and
provide the summed outputs to the trained machine learning model.

11. (canceled)

12. The system of claim 1, wherein the transmitter comprises an oscillator, a modulator, a power amplifier (PA), and an antenna; and the oscillator, the modulator, the power amplifier (PA), and the antenna are electrically coupled in series.

13. The system of claim 12, wherein the oscillator comprises at least one active resonator electrically coupled in parallel with a high-bandwidth inverting amplifier.

14. The system of claim 1, wherein the trained machine learning model was trained with a plurality of samples of an envelope of a received RF signal; and the trained machine learning model comprises a timing error function that includes each of the plurality of samples of the envelope of the received RF signal multiplied by a weight associated with that sample.

15. (canceled)

16. A cognitive radio (CR) receiver, comprising:
a low noise amplifier (LNA) electrically coupled in parallel with an automatic gain control (AGC) and a received signal strength indicator (RSSI) circuit, wherein the RSSI circuit comprises a plurality of limiting amplifiers;
a plurality of active resonators electrically coupled in series to an output of the LNA;
a plurality of rectifiers electrically coupled in series to the plurality of active resonators;
summation circuitry, electrically coupled in series to the plurality of rectifiers; and
a trained machine learning model electrically coupled in series to the summation circuitry,
wherein the receiver is configured to sense a predetermined frequency band for a CR signal, the summation circuitry is configured to sum outputs of the plurality of rectifiers and to provide the summed outputs to the trained machine learning model, and the trained machine learning model is configured to correct phase noise included in a CR signal.

17. The CR receiver of claim 16, wherein the RSSI circuit is configured to determine the power level of the CR signal; and the RSSI circuit is configured to control a gain of the LNA; and the RSSI circuit is further configured to prevent the saturation of the output in a received path for the AGC.

18. (canceled)

19. The CR receiver of claim 16, wherein the RSSI circuit is configured to continuously detect instability in the CR signal.

20. The CR receiver of claim 16, wherein each active resonator of the plurality of active resonators comprises a programmable resonant frequency, and each active resonator of the plurality of active resonators is associated with a quality factor.

21. A cognitive radio (CR) transmitter, comprising:
an oscillator;
a modulator;
a power amplifier (PA); and
an antenna;
wherein the oscillator, the modulator, the PA, and the antenna are electrically coupled in series, and the transmitter is configured to:
select a channel for CR signal transmission based on a predetermined frequency band, and
generate a carrier frequency for the selected channel.

22. The CR transmitter of claim 21, wherein the oscillator comprises at least one active resonator electrically coupled in parallel with a high-bandwidth inverting amplifier.

23. An active resonator comprising:
a transconductance stage followed by a common-source stage used in a negative feedback, wherein the transconductance stage corresponds to a transconductance value, the transconductance stage and the common-source stage correspond to an output resistance value, and the active resonator is associated with a quality factor;
a plurality of output capacitors electronically coupled to the transconductance stage and the common-source stage; and
a detuning resistor electronically coupled to the transconductance stage and the common-source stage, wherein the detuning resistor is configured to control the quality factor,
wherein the active resonator is configured to have a programmable resonant frequency.

24. The active resonator of claim 23, wherein the resonator is coupled to an RSSI circuit, the active resonator is configured to sweep the transconductance value to sense a narrow, predetermined signal over a wide band, and the RSSI circuit is configured to amplify and detect a power level of the narrow, predetermined frequency.

25. The active resonator of claim 23, wherein the programmable resonant frequency is programmed by changing a bias current; and the active resonator comprises two poles, each of the two poles corresponds to a resonant frequency of the active resonator, and the two poles are closely located.

26. (canceled)
